(19) United States
(12) Patent Application Publication
(10) Pub. No.: US 2026/0291278 A1
(43) Pub. Date: Sep. 24, 2026

(54) SYSTEMS AND METHODS FOR OPERATING AN OVERHEAD ELECTRICAL LINE

(71) Applicant: CTC Global Corporation, Irvine, CA (US)

(72) Inventors: Kevin Corbalis, Tustin, CA (US); Eric Bosze, San Diego, CA (US); David Goekjian, Anaheim, CA (US)

(21) Appl. No.: 19/472,396

(22) PCT Filed: Apr. 5, 2024
(86) PCT No.: PCT/US2024/023469

§ 371 Date: Oct. 3, 2025

Related U.S. Application Data
(60) Provisional application No. 63/494,455, filed on Apr. 5, 2023.

(51) Int. Cl. H02J 13/12; G05B 17/02; H02J 13/10; H02J 103/30

(52) U.S. Cl. CPC H02J 13/12; G05B 17/02; H02J 13/10; H02J 2103/30

(57) ABSTRACT

Systems and methods for the operation of an electrical line, such as an electrical line in an electrical transmission or distribution grid. The systems and methods may include the use of sensors such as distributed sensors and non-distributed sensors to collect data about the electrical line and utilize that data for taking action with respect to the electrical line, such as to improve transmission efficiencies and to mitigate outages.

### FIELD

This disclosure relates to the field of overhead electrical lines and methods for the operation and management of overhead electrical lines within an electrical power grid.

### SUMMARY

In one embodiment, a method for operating an overhead electrical line is disclosed. The method includes the steps of collecting distributed condition data at a first time from an optical fiber sensor extending along a length of an overhead electrical cable while the overhead electrical line is energized. The overhead electrical cable includes a fiber-reinforced composite strength member and an electrical conductor surrounding the fiber-reinforced composite strength member. The distributed condition data includes at least one of distributed cable temperature data and distributed cable strain data. The method also includes the step of adjusting current in the overhead electrical cable from a first current to a second current, wherein the adjusting reduces the absolute difference between the first current and an allowable current.

The foregoing method is subject to a number of refinements, characterizations and implementations, which may be applied to the foregoing method individually or in any combination.

In one characterization, the method further includes the step of determining the allowable current for the overhead electrical cable from the distributed condition data. In one refinement, the allowable current is greater than the first current, and the step of adjusting current in the overhead electrical cable comprises increasing the current in the overhead electrical cable.

In another characterization, the allowable current is less than the first current and the step of adjusting current in the overhead electrical cable comprises decreasing the current in the overhead electrical cable. In one implementation, the step of adjusting current in the overhead electrical cable comprises shunting electrical power from the overhead electrical line to a second overhead electrical line or to ground.

In another characterization, the method further includes collecting non-distributed condition data associated with the overhead electrical cable, wherein the step of determining the allowable current for the overhead electrical cable comprises supplementing the distributed condition data with the non-distributed condition data. In one implementation, the non-distributed condition data comprises at least one of an ambient temperature, a wind speed, a solar radiation value and a precipitation value.

In another characterization, the distributed condition data comprises at least distributed cable temperature data. In one implementation, the cable temperature data comprises a localized temperature value in the overhead electrical cable.

In another characterization, the distributed condition data comprises at least distributed cable strain data. In one implementation, the distributed cable strain data comprises a localized strain value in the overhead electrical cable.

In another characterization, the optical fiber sensor is embedded within the fiber-reinforced composite strength member.

In another characterization, the step of collecting distributed condition data comprises receiving distributed condition data from an OTDR (optical time domain reflectometer) that is operatively attached to the optical fiber sensor. In one implementation, the OTDR is a BOTDR (Brillouin optical time domain reflectometer). In a further implementation, the OTDR is operatively connected to a remote terminal unit (RTU), and wherein the RTU transmits the distributed condition data to a data acquisition server (DAS). In a further implementation, the DAS transmits data to a supervisory control and data acquisition (SCADA) system.

In another embodiment, a system for determining an electrical line power rating is disclosed. The system includes an optical fiber sensor extending along a length of an overhead electrical cable in an electrical line, the overhead electrical cable comprising a fiber-reinforced composite strength member and an electrical conductor surrounding the strength member, the optical fiber sensor being configured to provide distributed condition data along the length of the overhead electrical cable. An interrogation device is operatively connected to the optical fiber sensor and is configured to interrogate the optical fiber sensor and collect the distributed condition data from the optical fiber sensor, wherein the distributed condition data includes at least distributed temperature data. A data acquisition server (DAS) is configured to receive and analyze the distributed condition data from the interrogation device.

The foregoing system is subject to a number of refinements, characterizations and implementations, which may be applied to the foregoing system individually or in any combination.

In one characterization, the DAS is configured to receive and analyze the distributed condition data by calculating an allowable current for the overhead electrical cable based on the distributed condition data and outputting the allowable current to a control device. In one implementation, the DAS is configured to receive and analyze the distributed condition data by calculating a real time current carrying capacity of the overhead electrical cable and calculating a rate of change of temperature of the overhead electrical cable as a function of a change in current flowing through the overhead electrical cable.

In another characterization, the DAS is configured to receive and analyze second distributed condition data from the interrogation device, wherein the second distributed condition data is collected by the interrogation device at a time that is later than the collection of the first distributed condition data.

In another characterization, the control device is a human machine interface (HMI) device. In another characterization, the control device is an automated controller that is programmed to adjust the current in the overhead electrical cable based upon the calculated allowable current.

In another characterization, the DAS is operatively integrated with a supervisory control and data analysis (SCADA) system.

In another characterization, the interrogation device is further configured to collect distributed condition data, wherein the distributed condition data further includes distributed strain data.

In another characterization, the optical fiber sensor is embedded within the fiber-reinforced composite strength member.

In another characterization, the interrogation device is an optical time domain reflectometer (OTDR). In one implementation, the interrogation device is a Brillouin optical time domain reflectometer (BOTDR).

In another characterization, the DAS receives the distributed condition data from the interrogation device through a remote terminal unit (RTU).

In another embodiment, a method for operating an electrical power grid comprising an overhead electrical line is disclosed. The overhead electrical line includes an overhead electrical cable having a fiber-reinforced composite strength member and an electrical conductor surrounding the fiber-reinforced composite strength member. The method includes the step of determining at least a first environmental condition state from a geographical region, wherein at least a portion of the overhead electrical line is disposed within the geographical region. Distributed condition data is collected from a distributed sensor associated with the overhead electrical cable while the overhead electrical line is energized, where the distributed condition data comprises at least one of cable temperature data, cable strain data and cable vibration data from at least the portion of the overhead electrical line that is disposed within the geographical region. The environmental condition state and the distributed condition data are provided to a virtual model of the electrical power grid.

The foregoing method is subject to a number of refinements, characterizations and implementations, which may be applied to the foregoing method individually or in any combination.

In another characterization, the environmental condition state comprises at least one of an ambient temperature value, a wind speed value, a solar radiation value and a precipitation value.

In another characterization, the environmental condition state is determined from a non-distributed sensor. In one implementation, the non-distributed sensor is selected from a temperature sensor, a wind sensor, a solar radiation sensor and a precipitation sensor.

In another characterization, the environmental condition state is determined from a weather report.

In another characterization, the step of collecting distributed condition data comprises collecting distributed cable temperature data.

In another characterization, the step of collecting distributed condition data comprises collecting distributed cable strain data.

In another characterization, the step of collecting distributed condition data comprises collecting distributed cable vibration data.

In another characterization, the virtual model updates historical model data within the virtual model based on the environmental condition state and the distributed condition data input to the virtual model. In one implementation, the update to the historical model data includes the step of correlating the environmental condition state to the distributed condition data. In a further implementation, the method further includes the steps of determining a voltage or current in at least the portion of the overhead electrical line that is within the geographical region, and correlating the determined voltage or current in the portion of the overhead electrical line to the distributed condition data. In a further implementation, the method includes the steps of receiving a future weather forecast for the geographical region and modeling, in the virtual model of the electrical power grid, a future electrical line condition based upon the future weather forecast, the modeling comprising application of the correlated environmental condition state to the distributed condition data. In yet a further implementation, the modeling determines a projected voltage or current value for the portion of the overhead electrical line in the geographical region, wherein the projected voltage or current value is determined such that a pre-selected temperature of the overhead electrical line is not exceeded.

In another embodiment, a system for the measurement of temperature in real time in an overhead electrical line is disclosed. The system includes an overhead electrical cable comprising a fiber-reinforced composite strength member and an electrical conductor surrounding the composite strength member, wherein the overhead electrical cable is strung upon a plurality of support towers. An optical fiber sensor is embedded within and extends along a length of the composite strength member, the optical fiber sensor comprising a glass fiber core and a polymeric coating having a thickness of at least about 250 μm surrounding the glass fiber core, the optical fiber sensor having an outer diameter of at least about 600 μm. An optical time domain reflectometer (OTDR) is operatively attached to a first end of the optical fiber sensor, wherein the OTDR is configured to measure at least temperature profile data along the length of the optical fiber sensor.

The foregoing system is subject to a number of refinements, characterizations and implementations, which may be applied to the foregoing system individually or in any combination.

In another characterization, the polymeric coating surrounding the glass fiber core has a thickness of at least about 300 μm. In another characterization, the optical fiber sensor has an outer diameter of at least about 700 μm.

In another characterization, the polymeric coating surrounding the glass fiber is fabricated from a thermoplastic polymer. In one implementation, the thermoplastic polymer is selected from the group consisting of polyaryletherketone (PAEK), a liquid crystal polymer, a polyamide-imide and polybenzimidazole. In a further implementation, the thermoplastic polymer is a PAEK polymer. In yet a further implementation, the PAEK polymer is selected from the group consisting of polyetherketone (PEK), polyetheretherketone (PEEK), polyetherketoneketone (PEKK), polyetheretherketoneketone (PEEKK), and polyetherketoneetherketoneketone (PEKEKK). In yet a further implementation, the PAEK polymer comprises PEEK.

In another characterization, an end portion of the optical fiber sensor extends beyond a first end of the composite strength member. In one implementation, the OTDR is operatively attached to the end portion of the optical fiber sensor. In a further implementation, the OTDR is a Brillouin optical time domain reflectometer (BOTDR).

In another characterization, the system includes a remote terminal unit (RTU) in operative communication with the OTDR. In one implementation, the RTU is in operative communication with a data acquisition server (DAS) to enable the RTU to transmit the temperature profile data along the length of the optical fiber sensor to the DAS.

In another characterization, the OTDR is in wireless communication with a DAS. In another characterization, the OTDR is in communication with the DAS through an optical ground wire (OPGW).

In another characterization, the DAS is configured to convert the temperature profile data to readable temperature measurements and to transmit the readable temperature measurements to a human machine interface (HMI). In one implementation, the HMI includes a processor that is programmed to overlay the readable temperature measurements onto a geographical map.

In another characterization, the optical fiber sensor is a single optical fiber sensor embedded within the composite strength member.

In another characterization, the OTDR is configured to measure strain profile data along the length of the optical fiber sensor.

In another characterization, the fiber-reinforced composite strength member comprises carbon reinforcing fibers in a polymer matrix. In one implementation, the fiber-reinforced composite strength member comprises an insulating layer surrounding the carbon reinforcing fibers. In another characterization, the electrical conductor comprises a plurality of aluminum strands wrapped around the composite strength member.

These and other embodiments, characterizations and implementations of systems and methods will be apparent from the following description.

### DESCRIPTION OF THE DRAWINGS

FIG. 1 illustrates a portion of an overhead electrical line.

FIG. 2 illustrates a cross-sectional view of an assembled dead-end termination apparatus.

FIG. 3 illustrates a perspective view of an assembled and crimped dead-end termination apparatus.

FIG. 4 illustrates a cross-sectional view of a splice that is useful for connecting two electrical cable segments.

FIGS. 5A and 5B illustrate perspective views of overhead electrical cables including fiber-reinforced composite strength members.

FIGS. 6A and 6B illustrate cross-sectional views of fiber-reinforced composite strength members incorporating optical fibers embedded within the fiber-reinforced composite material.

FIG. 7 illustrates a perspective view of an overhead electrical cable incorporating an optical fiber on a surface of the strength member.

FIG. 8 illustrates a perspective view of a portion of a transmission line incorporating several non-distributed sensors.

FIG. 9 illustrates a cross-sectional view of a non-distributed sensor disposed within a dead-end apparatus.

FIG. 10 schematically illustrates an interrogation system showing communication between various components of the system.

FIG. 11 illustrates an interrogation system including a non-distributed sensor affixed to an electrical cable.

### DESCRIPTION

An electrical power grid is a networked system that produces and delivers electricity, i.e., electrical power, to end users. Broadly characterized, an electrical power grid is comprised of power generation sources that generate the electrical power, transmission lines for transmitting the electrical power over long distances at high voltage, substations including transformers for decreasing or increasing the electrical voltage, and distribution lines for distributing the electrical power to end users at lower voltages. The transmission lines are predominately overhead transmission lines that include a plurality of electrical cables suspended upon support towers, also known as pylons. The suspended electrical cables that conduct the electricity at relatively high voltage, e.g., about 60 kV or higher. Because the electricity in an electrical power grid is predominately transmitted in the form of alternating current (AC), each transmission line includes at least 3 electrical cables to transmit the electricity in three phases. Each set of 3 electrical cables can be characterized as a single electrical circuit. Transmission lines may be composed of a single electrical circuit or may be composed of two or more electrical circuits, i.e., two or more overhead electrical lines.

In a similar manner, distribution lines are configured to carry electricity at lower voltages, e.g., less than about 60 kV, over shorter distances using overhead electrical cables, typically in an AC configuration.

This disclosure relates to systems and methods for the operation of an overhead electrical line, e.g., as a component of an electrical power grid. Although the following disclosure primarily refers to the transmission and/or distribution of electricity in a 3-phase AC configuration, the systems and methods disclosed herein may also be applied to a DC (direct current) electrical line. Thus, as used herein, the term overhead electrical line encompasses both overhead transmission lines and overhead distribution lines and is used to refer to either a single electrical cable in the case of DC power or to 3 electrical cables forming an electrical circuit in the case of AC power. In either event, overhead electrical lines include long electrically conducting cables that are supported above the ground by a series of support towers. As is described below, overhead electrical lines also include other critical components such as hardware for attaching the electrical cables to the support towers and insulators for preventing the leakage of electrical current from the electrical cables to the underlying terrain.

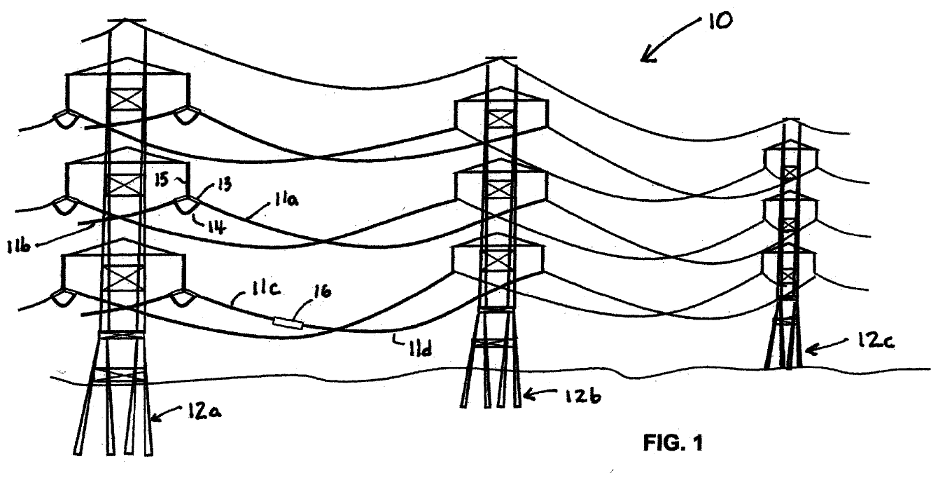

FIG. 1 illustrates such an overhead electrical line 10, specifically an overhead transmission line. The transmission line 10 includes overhead electrical cables that conduct electricity and that are supported above the terrain by two or more support towers such as support towers 12a/12b/12c. Specifically, the transmission line 10 includes two electrical circuits, each circuit including three electrical cables for the transmission of AC power. Transmission lines may span many kilometers, requiring extremely long lengths of electrical cable. As a result, the electrical cable is typically comprised of two or more electrical cable segments that are electrically joined together to form a continuous electrical pathway along the transmission line.

As noted above, one function of the support towers is to safely elevate the electrical cables above the terrain. In this regard, the electrical cables are attached to the support towers using different types of hardware. Some of the support towers are referred to as dead-end towers or anchor towers, such as tower 12a. Dead-end towers are located at termination points, e.g., at substations or at locations where the electrical line is routed underground. Dead-end towers such as tower 12a may also be required where the electrical cables change direction (e.g., make a turn), cross a roadway or other structure where there is a high risk of damage or injury if the electrical cable fails, or at regular intervals in a long, straight path. In such instances, two electrical cable segments are mechanically attached to the dead-end tower under high tension and are electrically connected to form a continuous electrical pathway. As illustrated in FIG. 1, electrical cable segment 11a is secured (e.g., anchored) to tower 12a using a dead-end termination 13 (e.g., a tension clamp) and is electrically connected to an adjacent electrical cable segment 11b through an electrical jumper 14. The electrical cable segments 11a/11b are insulated from the support tower 12a by an insulator string 15.

Another hardware component that may be used an electrical line is referred to as a splice. While the length of a single overhead cable segment may be several thousand meters, a transmission line may span several hundred kilometers over which the electrical power must be transmitted. To span these distances, the linemen must occasionally join two electrical cable segments together, e.g., between support towers. In this case, one or more splices may be utilized to join two electrical cable segments. The splice functions as a mechanical junction that holds the two ends of the electrical cable segments together and as an electrical junction allowing the electric current to flow through the splice. As illustrated in FIG. 1, a splice 16 operatively connects electrical cable segment 11c to electrical cable segment 11d to form a mechanical junction and a continuous electrical pathway.

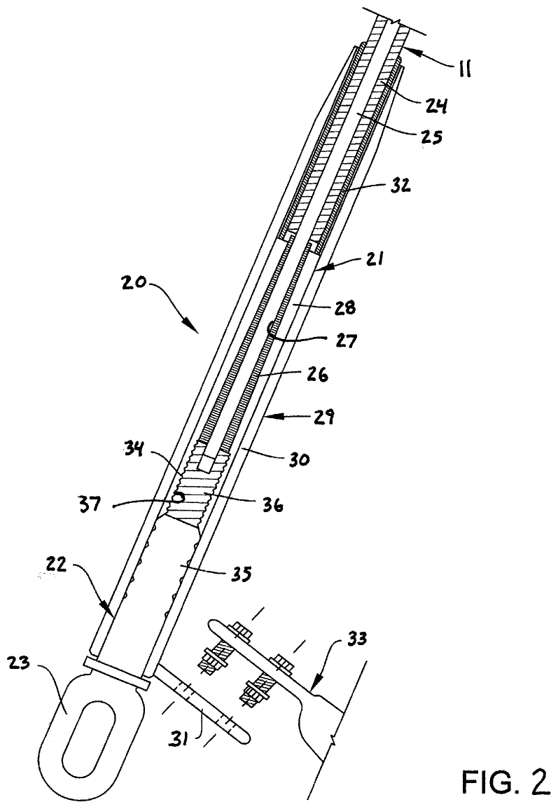

FIG. 2 illustrates a cross-section of an assembled termination apparatus (e.g., a dead-end) such as dead-end 13 illustrated in FIG. 1. The dead-end 20 illustrated in FIG. 2 is similar to that illustrated and described in PCT Publication No. WO 2005/041358 by Bryant and in U.S. Pat. No. 8,022,301 by Bryant et al., each of which is incorporated herein by reference in its entirety.

Broadly characterized, the dead-end 20 includes a gripping assembly 21 and a connector 22 for anchoring the dead-end 20, e.g., to a tower as illustrated in FIG. 1, with a fastener 23 disposed at a proximal end of the dead-end 20. At the distal end of the dead-end 20, opposite the fastener 23, the dead-end 20 is operatively connected to an overhead electrical cable segment 11 that includes an electrical conductor 24 that surrounds and is supported by a strength member 25, e.g., a fiber-reinforced composite strength member, sometimes referred to as a core.

The gripping assembly 21 tightly grips the strength member 25 to secure the overhead electrical cable segment 11 to the dead-end 20. As illustrated in FIG. 2, the gripping assembly 21 includes a compression-type fitting (e.g., a wedge-type fitting), specifically a collet 26 having a collet lumen 27 (e.g., a bore) that surrounds and grips onto the strength member 25. The collet 26 is disposed in a collet housing 28, and as the electrical cable segment 11 is tensioned (e.g., is pulled onto support towers), friction develops between the strength member 25 and the collet 26 as the collet is pulled further into the collet housing 28. The outer conical shape of the collet 26 and the mating inner funnel shape of the collet housing 28 increase the compression on the strength member 25, ensuring that the strength member does not slip out of the collet 26 and therefore that the overhead electrical cable segment 11 is secured to the dead-end 20.

The connector 22 includes the fastener 23 (e.g., an eyebolt) and gripping assembly mating threads 34 disposed at a gripping assembly end 36 of a connector body 35. The gripping assembly mating threads 34 are configured to operatively mate with connector mating threads 37 on an inner surface of the collet housing 28 to facilitate movement of the connector 22 against the collet 26, pushing the collet 26 into the collet housing 28 when the mating threads 34 and 37 are engaged and the connector 22 is rotated relative to the collet housing 28. This strengthens the compressive grip of the collet 26 onto the strength member 25, further securing the overhead electrical cable 11 to the dead-end 20. The fastener 23 is configured to be attached to a dead-end tower as illustrated in FIG. 1, to secure the dead-end 20 and therefore the electrical cable 11, to the dead-end tower.

As illustrated in FIG. 2, an outer sleeve 29 is disposed over the gripping assembly 21 and an end of the electrical cable segment 11. The outer sleeve 29 includes a conductive body 30 to facilitate a continuous electrical pathway between the electrical conductor 24 and a jumper plate 31. An inner sleeve 32 (e.g., a conductive inner sleeve) may be placed between the conductor 24 and the conductive body 30 to facilitate the electrical connection between the conductor and the conductive body. The conductive body 30 may be fabricated from aluminum and the jumper plate 31 may be integrally formed with or welded onto the conductive body. The jumper plate 31 is configured to attach to a connector plate 33 to facilitate the formation of an electrical pathway between the electrical cable segment 11 and another electrical cable segment (not illustrated), e.g., through a jumper cable as illustrated in FIG. 1.

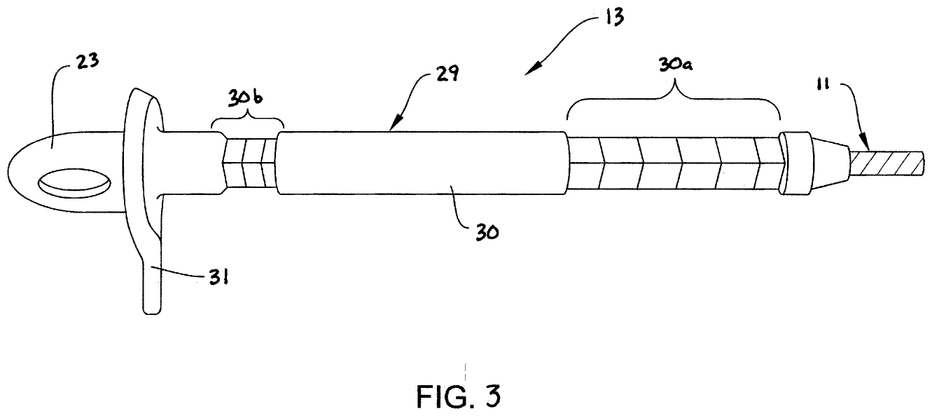

FIG. 3 illustrates a perspective view of a dead-end 13 that has been crimped (e.g., compressed) onto an overhead electrical cable segment 11. The dead-end 13 includes a connector having a fastener 23 that extends outwardly from a proximal end of an outer sleeve 29. A jumper plate 31 is integrally formed with the outer conductive sleeve body 30 for electrical connection to a connection plate as illustrated in FIG. 2. As illustrated in FIG. 3, the outer sleeve conductive body 30 is crimped over (e.g., crimped onto) two regions of the underlying structure, namely crimped sleeve body region 30a and crimped sleeve body region 30b. The crimped sleeve body region 30b is generally situated over an intermediate portion of the underlying connector and the crimped sleeve region 30a is generally situated over a portion of the electrical cable segment 11 (e.g., see FIG. 2). The compressive forces placed onto the outer sleeve body 29 during the crimping operation are transferred to the underlying components, i.e., to the connector under the crimped region 30b and to a portion of the electrical cable segment 11 under the crimped region 30a to permanently secure the conductive body 30 to the electrical cable segment 11 and to the underlying connector.

The dead-end broadly described with respect to FIGS. 2 and 3 can be utilized with various overhead electrical cable configurations. The dead-end illustrated in FIGS. 2 and 3 is particularly useful with overhead electrical cables having a fiber-reinforced composite strength member. For example, a compression wedge gripping element, e.g., having a collet disposed in a collet housing (e.g., FIG. 2), enables a fiber-reinforced composite strength member to be gripped under a high compressive force without significant risk of fracturing the composite material. However, those of skill in the art will recognize that other configurations for such dead-ends are disclosed in the art and the foregoing illustrations are merely examples of one configuration that may be used to secure an overhead electrical cable segment to a structure such as a support tower.

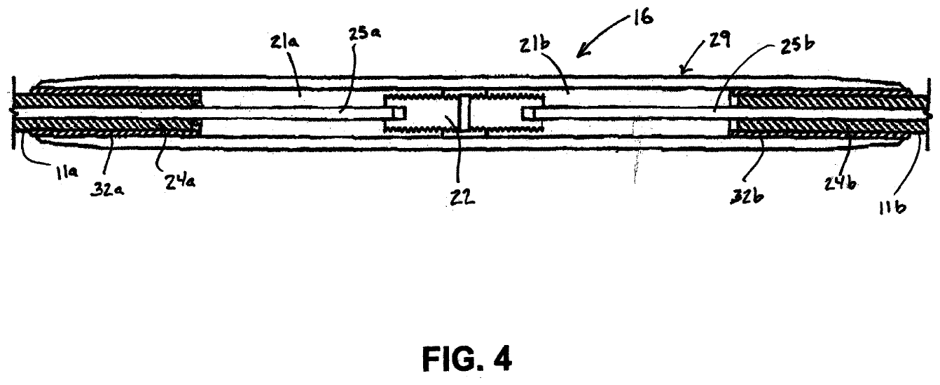

FIG. 4 illustrates a cross-sectional view of a splice 16, e.g., a splice as illustrated in FIG. 1. As illustrated in FIG. 1, a splice is configured to mechanically and electrically connect the ends of two overhead cable segments to form a continuous electrical pathway between the two cable segments. As illustrated in FIG. 4, the splice 16 connects two electrical cable segments 11a and 11b. The splice 16 includes gripping assemblies 21a and 21b that operatively grip electrical cable segments 11a and 11b, respectively. The gripping assemblies may include a collet and housing configuration as illustrated in FIG. 2, for example. To mechanically join the two electrical cable segments, the gripping assemblies 21a/21b are connected to, e.g., threadably engaged with, a single connector 22. To form a continuous electrical pathway between the electrical cables 11a/11b, e.g., between two electrical conductors 24a/24b, a conductive outer sleeve 29 is placed over the underlying structure and is crimped onto at least the connector body 22 and the ends of the electrical cables 24a and 24b. Conductive inner sleeves 32a/32b may be inserted between the conductors 24a/24b and the outer sleeve 29 to facilitate a robust electrical connection therebetween. As with the dead-ends illustrated in FIGS. 2 and 3, those of skill in the art will recognize that other configurations for splices are disclosed in the art and the foregoing illustration is merely one example that may be utilized to electrically and mechanically connect two electrical cable segments.

The systems and methods disclosed herein may be implemented with electrical lines that incorporate overhead electrical cables having a variety of configurations. One traditional configuration is referred to as aluminum conductor steel reinforced cable (ACSR) cable wherein outer aluminum conductor strands are supported by a strength member having a plurality of steel wires that are twisted, e.g., stranded, together to form the strength member. Other configurations implementing a strength member formed from a plurality of twisted metal wires include aluminum core steel supported (ACSS) cables. These and similar configurations are known to those of ordinary skill in the art.

While the systems and methods disclosed herein may be implemented with electrical lines that incorporate these traditional types of overhead electrical cables, in certain embodiments the systems and methods are particularly useful when the electrical lines incorporate one or more electrical cable segments that utilize a fiber-reinforced composite strength member. As used herein, a fiber-reinforced composite strength member is a strength member that includes an elongate structural element that comprises reinforcing fibers in a binding matrix. Such composite materials offer many benefits including lightweight, advantageous mechanical properties such as a high tensile strength and a low coefficient of thermal expansion (CTE) as compared to metal strength elements such as steel wires, for example. Such a strength member may comprise a single (i.e., no more than one) fiber-reinforced strength element (e.g., a one-piece fiber-reinforced composite strength member), or may be comprised of several fiber-reinforced composite strength elements that are combined (e.g., twisted, stranded or otherwise bundled together) to form the strength member. As such, the present disclosure may use the terms strength member and strength element interchangeably, particularly where the strength member includes a single strength element.

The systems and methods disclosed herein may be utilized with electrical lines having one or more electrical cable segments that incorporate strength members and at least one distributed sensing element. A distributed sensing element is an elongate wire or strand that enables location-specific data to be obtained along a length of the distributed sensing element. In one particular characterization, the distributed sensing element comprises at least one optical fiber, e.g., an optical fiber sensor. As used herein, the term optical fiber refers to an elongate and continuous fiber that is configured to transmit incident light down a length of the fiber. Typically, glass optical fibers include a transmissive core and a cladding layer surrounding the core that is fabricated from a different material (e.g., having a different refractive index) to reduce the loss of light out of the transmissive core and through the exterior of the optical fiber. The optical fibers can be single mode optical fibers or a multimode optical fibers. A single mode optical fiber has a small diameter transmissive core (e.g., about 9 μm in diameter) surrounded by a cladding and having a total diameter of about 125 μm. Single mode fibers are configured to allow only one mode of light to propagate. A multimode optical fiber has a larger transmissive core, e.g., about 50 μm in diameter or larger, that allows multiple modes of light to propagate. Multimode optical fibers also include a cladding surrounding the transmissive core. The optical fibers may be fabricated entirely from one or more polymers. However, polymer optical fibers may not have sufficient optical attenuation and adequate heat resistance to withstand manufacture and/or use of the strength member incorporating the optical fiber. In this regard, glass optical fibers are preferred for use as an optical fiber sensor, e.g., for their low attenuation.

In one characterization, the optical fiber may be characterized as having a glass fiber core and a polymeric coating having a thickness of at least about 250 μm surrounding the glass fiber core, where the optical fiber has an outer diameter of at least about 600 μm. For example, the polymeric coating surrounding the glass fiber core may have a thickness of at least about 300 μm. In another example, the optical fiber has an outer diameter of at least about 700 μm, such as at least about 800 μm. The polymeric coating surrounding the glass core may advantageously be fabricated from a thermoplastic polymer, and in one construction the thermoplastic polymer is selected from the group consisting of polyaryletherketone (PAEK), a liquid crystal polymer, a polyamide-imide and olybenzimidazole. For example, the thermoplastic polymer may be a PAEK polymer, e.g., a PAEK polymer selected from the group consisting of polyetherketone (PEK), olyetheretherketone (PEEK), polyetherketoneketone (PEKK), polyetheretherketoneketone (PEEKK), and polyetherketoneetherketoneketone (PEKEKK).

Although the present disclosure contemplates the use of other types of distributed sensing elements, this disclosure will generally refer to the use of optical fiber sensors. However, it is to be understood that the present disclosure is not strictly limited to use with optical fibers as the distributed sensing element and other distributed sensing elements may be utilized.

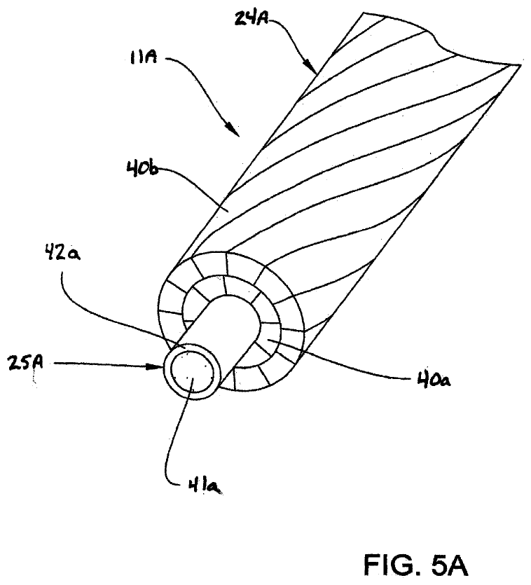

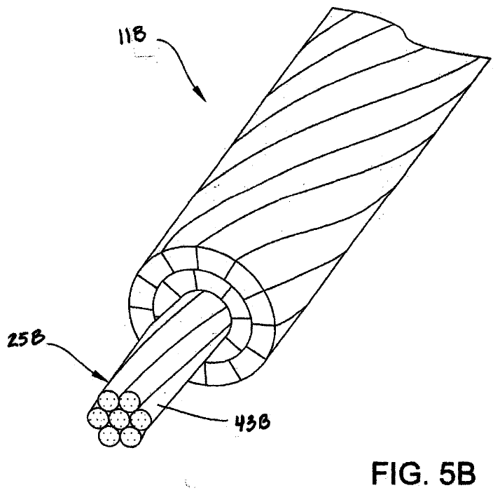

As noted above, overhead electrical cables typically include a central strength member and an electrical conductor disposed around and supported by the strength member. Although the strength member has traditionally been fabricated from steel, such steel strength members are increasingly being replaced by strength members fabricated from composite materials, particularly from fiber-reinforced composite materials, which offer many significant benefits. Such fiber-reinforced composite strength members may include a single fiber-reinforced composite strength element as is illustrated in FIG. 5A. Alternatively, the composite strength member may be comprised of a plurality of individual fiber-reinforced composite strength elements (e.g., individual rods) that are operatively combined (e.g., twisted or stranded together) to form the strength member, as is illustrated in FIG. 5B.

Referring to FIG. 5A, the overhead electrical cable 11A includes an electrical conductor 24A comprising a layer of first conductive strands 40a that are helically wrapped around a fiber-reinforced composite strength member 25A, which comprises a single fiber-reinforced composite strength element. A second layer of conductive strands 40b are helically wrapped around the first conductive strands 40a to increase the volume of the electrical conductor 24A. The conductive strands 40a/40b may be fabricated from conductive metals such as copper or aluminum, and for use in bare overhead electrical cables are typically fabricated from aluminum, e.g., hardened aluminum, annealed aluminum, and/or aluminum alloys. The conductive materials, e.g., aluminum, do not have sufficient mechanical properties (e.g., sufficient tensile strength) to be self-supporting when strung between support towers, thus necessitating the use of the strength member 25A. In the configuration illustrated in FIG. 5A, the fiber-reinforced composite strength member 25A includes a single strength element having a high tensile strength section 41a (e.g., comprising carbon fibers) surrounded by a galvanic layer 42a that prevents adverse reactions between the carbon in the high tensile strength section 41a and the aluminum strands 40a. The galvanic layer 42a comprises glass fibers that are also disposed in a binding matrix and is integrally formed, e.g., pultruded, with the high tensile strength section 41a. Alternatively, a galvanic layer may be formed around a high tensile strength section by wrapping a tape or disposing a polymer around the high tensile strength section.

FIG. 5B illustrates an embodiment of an overhead electrical cable 11B that is similar to the electrical cable illustrated in FIG. 5A, where the strength member 25B comprises a plurality of individual fiber-reinforced strength elements (e.g., strength element 43B) that are stranded together to form the strength member 25B. Although illustrated in FIG. 5B as including seven individual strength elements, multi-element strength members may include any number of strength elements that is suitable for a particular application. The individual strength elements may be formed with carbon fibers and each element may include a galvanic layer as illustrated in FIG. 5A. Alternatively, or in addition, the bundle of strength elements may be entirely surrounded by a galvanic layer 42a such as by wrapping an insulative tape around the bundle of strength elements. Examples of such multi-element composite strength members include, but are not limited to: the multi-element aluminum matrix composite strength member illustrated in U.S. Pat. No. 6,245,425 by Mccullough et al.; the multi-element carbon fiber strength member illustrated in U.S. Pat. No. 6,015,953 by Tosaka et al.; and the multi-element strength member illustrated in U.S. Pat. No. 9,685,257 by Daniel et al. Each of these U.S. patents is incorporated herein by reference in its entirety. Other configurations for the fiber-reinforced composite strength member may be utilized in the electrical cables.

As noted above, the fiber-reinforced composite from which the fiber-reinforced strength member is fabricated includes reinforcing fibers that are operatively disposed in a binding matrix. The reinforcing fibers are typically substantially continuous reinforcing fibers that extend along the length of the fiber-reinforced composite, although the fiber-reinforced composite may include short reinforcing fibers (e.g., fiber whiskers or chopped fibers) that are dispersed through the binding matrix. The reinforcing fibers may be selected from a wide range of materials, including but not limited to, carbon, glass, boron, metal oxides, metal carbides, high-strength polymers such as aramid fibers or fluoropolymer fibers, basalt fibers and the like. Carbon fibers are particularly advantageous due to their very high tensile strength, and/or due to their relatively low coefficient of thermal expansion (CTE).

The binding matrix may include, for example, a plastic (e.g., polymer) such as a thermoplastic polymer or a thermoset polymer. The binding matrix may also be a metallic matrix, such as an aluminum matrix. One example of an aluminum matrix fiber-reinforced composite is illustrated in U.S. Pat. No. 6,245,425 by Mccullough et al., which is incorporated herein by reference in its entirety.

One configuration of a composite strength member for an overhead electrical cable that is particularly advantageous is the ACCC® composite configuration that is available from CTC Global Corporation of Irvine, CA and is illustrated in U.S. Pat. No. 7,368,162 by Hiel et al., noted above. In the commercial embodiment of the ACCC® electrical cable, the strength member is a single element strength member of substantially circular cross-section that includes an inner core of substantially continuous reinforcing carbon fibers disposed in a polymer matrix. The core of carbon fibers is surrounded by a robust insulating layer of glass fibers that are also disposed in a polymer matrix and are selected to insulate the carbon fibers from the surrounding conductive aluminum strands. See FIG. 5A. The glass fibers also have a higher elastic modulus than the carbon fibers and provide bendability so that the strength member and the electrical cable can be wrapped upon a spool for storage and transportation.

Although the foregoing characteristics of a fiber-reinforced strength member are disclosed as being desirable for use in an overhead electrical cable, similar characteristics may also be desirable when the strength members disclosed herein are used in other structures, such as bridge cables and messenger cables.

Although not limited thereto, in certain embodiments the systems and methods for operating an overhead electrical line rely upon the implementation of at least one distributed sensor such as an optical fiber sensor. As used herein, a distributed sensor is a sensor that is capable of obtaining data, e.g., making measurements, along a substantially continuous length of the sensor. For example, an optical fiber sensor that extends along a length of an electrical cable enables detection of temperature and/or strain along substantially the entire length of the electrical cable. As such, the data that is collected and analyzed from the distributed sensor may also include an identification of the location of the measurement along the distributed sensor. The distributed sensor may be associated with the electrical cable by being placed within the electrical cable. For example, a distributed sensor may be placed within the conductive strands along a length of the electrical cable. In one characterization, the optical fiber is associated with the strength member of at least one of the electrical cable segments. By operatively associating the optical fiber with a strength member, it may be possible to determine certain important properties of the strength member such as the strain that the strength member is experiencing at a particular location.

In this regard, at least one elongate and continuous optical fiber, e.g., an optical fiber sensor, may be operatively associated with the fiber-reinforced composite strength member. In one configuration, the optical fiber sensor may be embedded within the fiber-reinforced composite (e.g., within the binding matrix). The optical fiber sensor may extend from a first end of the strength member to a second end of the strength member, e.g., such that the entire length of the optical fiber sensor, and substantially the entire length of the overhead electrical cable, may be interrogated through the optical fiber sensor. By proper selection of the type of optical fiber sensor and placement of the optical fiber sensor, the strength member and the electrical cable segment can be interrogated to assess the condition of the strength member. Although a single optical fiber sensor may be utilized in an overhead electrical cable, the efficacy of the systems and methods disclosed herein may be improved by including multiple optical fiber sensors wherein at least one of the optical fiber sensors is associated with the strength member.

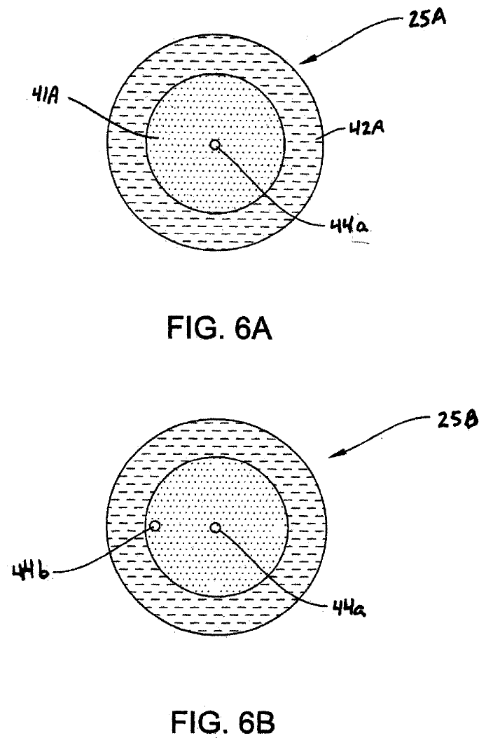

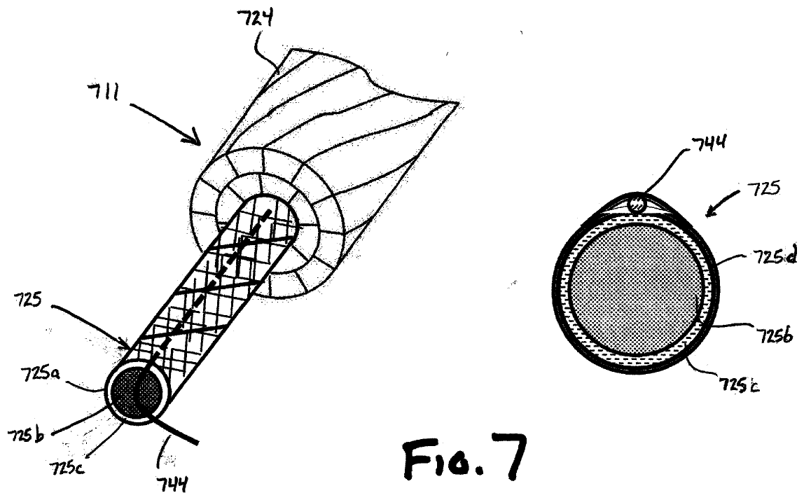

Referring to FIGS. 6A and 6B, cross-sectional views of single element fiber-reinforced composite strength members are illustrated. The configuration of the fiber-reinforced strength members is similar to the strength element illustrated in FIG. 5A, including an inner section of high tensile strength fibers surrounded by an outer layer of an insulative material, e.g., an inner section comprising carbon fibers surrounded by an outer galvanic layer comprising glass fibers. As illustrated in FIG. 6A, the fiber-reinforced composite strength member 25A includes a single optical fiber sensor 44a that is centrally disposed within the strength member 25A, i.e., centrally disposed within the high strength section 41A. Stated another way, the optical fiber sensor 44a is disposed substantially along a central axis of the strength member 25A. In the configuration illustrated in FIG. 6B, the strength member is configured in a similar manner as the configuration illustrated in FIG. 6A. As illustrated in FIG. 6B, the strength member 25B includes a second optical fiber sensor 44b in addition to the optical fiber sensor 44a. The optical fiber sensor 44b is offset from the optical fiber sensor 44a, i.e., is offset from a central axis of the strength member 25B. In any event, the placement of at least one optical fiber sensor along a central axis of the strength member may advantageously reduce or eliminate the effect of bending modes upon the optical fiber sensor. Examples of different configurations of optical fibers embedded in the fiber-reinforced composite strength member are illustrated in US Patent Publication No. 2021/0048469 by Dong et al., which is incorporated herein by reference in its entirety.

It will be appreciated that FIGS. 6A and 6B are merely illustrative of possible configurations wherein optical fiber sensors are operatively associated with fiber-reinforced composite strength members. For example, the fiber-reinforced strength members may incorporate more than one or two optical fiber sensors, such as three, four or more optical fiber sensors. Such additional optical fiber sensors may be used for enhanced measurement sensitivity, for redundancy or for other reasons. In any event, by incorporating the optical fiber sensor(s) within the fiber-reinforced composite strength member, e.g., within the binding matrix, certain advantages may be realized. For example, the optical fiber sensor is fully protected (e.g., shielded) from the exterior environment by the binding matrix, ensuring that natural or man-made environmental factors (e.g., impact stresses) will not significantly impair the performance of the optical fiber sensor. Further, the optical fiber sensor is physically and intimately bound to the matrix within the fiber-reinforced composite such that forces that act upon the fiber-reinforced composite strength member (e.g., tensile strain) will be fully and consistently transmitted to the optical fiber sensor along the entire length of the strength member, ensuring accurate distributed measurements.

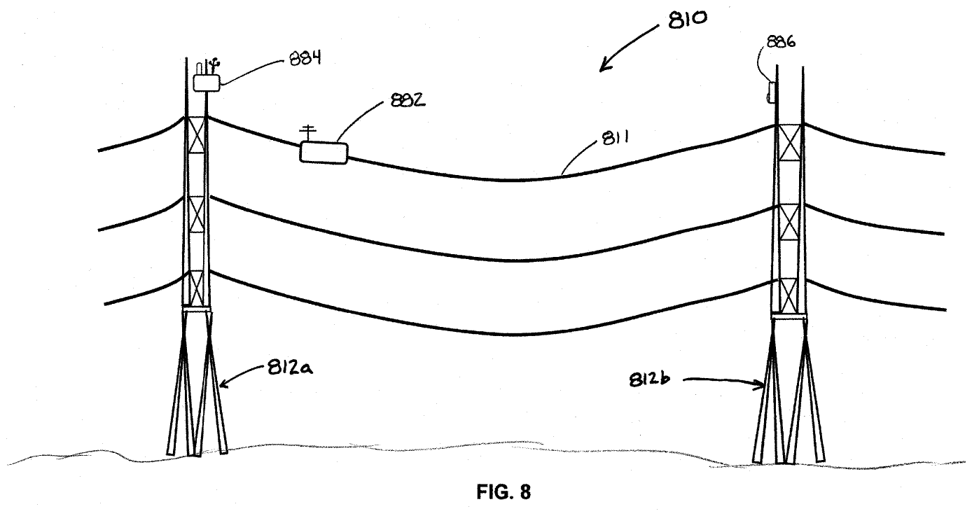

A distributed sensing element, e.g., an optical fiber sensor, may also be associated with a fiber-reinforced strength member, and hence with an electrical cable including the strength member, by alternative means. For example, one or more optical fiber sensors may be affixed to an outer surface of the strength member along the length of the strength member. FIG. 7 illustrates a perspective view of one exemplary embodiment of an overhead electrical cable 711 and a cross-sectional view of the strength member assembly 725 according to this construction. The electrical cable 711 includes a strength member assembly 725 that includes a strength member 725a having a high tensile strength fiber-reinforced composite core 725b including carbon fibers and a galvanic layer 725c of glass fibers in a binding matrix. An electrical conductor 724 surrounds the strength member assembly 725. In the embodiment illustrated in FIG. 7, the strength member assembly 725 includes an optical fiber sensor 744 that is linearly disposed along an outer surface of the strength member 725a. A tape layer 725d is wound around the strength member 725a and the optical fiber sensor 744 to couple the optical fiber sensor to the strength member and form the strength member assembly 725. Specifically, the tape layer 725d comprises a strip of tape that is helically wound around the strength member 725a in a manner such that the tape overlaps upon itself along seams such that the tape layer 725d covers the entire strength member (e.g., with no substantial gaps) and the optical fiber sensor 744, and such that the tape layer 725d lies between the optical fiber sensor 744 and the electrical conductor 724 along its length. It will be appreciated that the construction illustrated in FIG. 7 is merely exemplary and that optical fiber sensors may be associated with electrical cables using other constructions. Examples of such other constructions are disclosed in PCT Publication No. WO 2021/222663 by Webb et al. which is incorporated herein by reference in its entirety.

The fiber-reinforced strength elements described above may be fabricated by means known to those of skill in the art. In one example, the fiber-reinforced composite strength member is formed by pultrusion process whereby tows of continuous reinforcing fibers (e.g., carbon and glass fibers) are pulled through a binding matrix material (e.g., through an epoxy resin bath), which is subsequently cured to bind the fibers and form a fiber-reinforced composite. Optical fibers are provided by the manufacturer in continuous lengths (e.g., of many thousands of meters) on spools in a manner similar to the fiber tows (e.g., carbon fiber tows and glass fiber tows). Therefore, the optical fibers can be integrated into the pultrusion process along with the reinforcing fibers.

One reason that optical fiber sensors are preferable is that devices and methods for collecting distributed data from optical fibers are known in the art. For example, the optical fiber sensors may be operatively coupled to an interrogation device that includes a coherent light source (e.g., a pump laser source) to enable the light to be passed (e.g., pulsed) into the optical fiber sensor in a controlled manner. The light source may be configured to send a signal (e.g., a pulse) down the optical fiber sensor, and the interrogation (e.g., the measurement) of the condition in the optical fiber sensor is performed by analyzing light that is backscattered by the optical fiber. In this regard, the interrogation device may include a signal detector such as an interferometer, that is configured to detect the backscattered light signals.

For example, the components of the backscattered light can be categorized as Rayleigh components, Brillouin components and Raman components. The backscattered Rayleigh components have the same frequency (i.e., the same wavelength) as the primary light source and have a relatively high intensity. The backscattered Rayleigh components can be analyzed to determine the length of the optical fiber by using Optical Time Domain Reflectometry (OTDR). Thus, backscattered Rayleigh components may be used to detect a break in the optical fiber indicating possible damage to the fiber-reinforced composite strength member. However, the backscattered Rayleigh components are not capable of providing any further significant information about the conditions of the optical fiber.

In one characterization, the interrogation device implements the OTDR analysis of at least one of Raman backscattered light components (e.g., a Raman distributed sensor) and Brillouin backscattered light components (e.g., a Brillouin distributed sensor). Both Raman and Brillouin distributed sensor systems make use of a non-linear interaction between the primary light signal and the optical fiber. When a primary light signal of known wavelength is input to an optical fiber, a very small amount of the light signal is scattered back (e.g., a backscattered light signal) at every point along the optical fiber. The backscattered light contains shifted components at wavelengths that are different than the primary light signal. Light components that are shifted to a longer wavelength (i.e., lower energy) are referred to as Stokes components, whereas light components that are shifted to a shorter wavelength (i.e., higher energy) are referred to as anti-Stokes components. These shifted backscattered light components can be detected and analyzed to ascertain information about the local conditions of the optical fiber, such as its strain and temperature at different points along the length of optical fiber.

In one configuration, at least one of the optical fibers is utilized as a Raman distributed temperature sensor. In a Raman distributed temperature sensor, the interaction between the primary light signal (e.g., the pump laser signal) and optical phonons in the optical fiber material (e.g., silica glass) creates two backscattered light components in the backscattered light spectrum, Raman Stokes and Raman anti-Stokes. The Raman anti-Stokes component is temperature dependent, i.e., the intensity of the Raman anti-Stokes component increases with increasing temperature of the sensing optical fiber. As a result, the relative intensity of the Raman Stokes and the Raman anti-Stokes backscattered light components can be measured and used to determine a temperature of the optical fiber sensor. The Raman Stokes and Raman anti-Stokes backscattered light components can be detected by a signal detector such as an interferometer or a dispersive spectrometer, which may be a component of the interrogation device.

The position of the temperature reading along the length of the optical fiber can also be determined from the Raman backscattered light components. When a pulsed light signal is used to interrogate the optical fiber, the back-scattered intensity of the Raman Stokes and Raman anti-Stokes backscattered light components can be recorded as a function of time (e.g., “round trip” time), enabling the capture of a temperature profile along the length of the optical fiber sensor, i.e., along the length of the fiber-reinforced composite strength member.

In one example, the optical fiber sensor operatively associated with the fiber-reinforced composite strength member includes a multi-mode optical fiber. The multi-mode optical fiber sensor having a high numeric aperture may increase the intensity of the backscattered light which can be important due to the relatively low magnitude of the Raman backscattered light signals.

In another configuration, the interrogation device incorporates Brillouin distributed sensing to interrogate the optical fiber sensor. Brillouin distributed sensors utilize Brillouin backscattering, which is the result of an interaction between the primary light signal and time dependent optical density variations within the optical fiber sensor (i.e., acoustic phonons). The acoustic phonons create a periodic modulation of the refractive index (e.g., the optical density) of the optical fiber sensor material. Brillouin scattering occurs when the propagating primary light signal is diffracted back by this moving “grating,” resulting in a frequency and wavelength shifted component in the backscattered light signal.

As the temperature of the optical fiber sensor increases, the wavelength of the Brillouin backscattered components shifts further away from the primary wavelength. This wavelength shift can be utilized to determine the temperature of the optical fiber sensor. As with a Raman distributed temperature sensor, the location of the temperature reading along the length of the optical fiber sensor can be determined using time of flight information for the backscattered light signal.

Unlike Raman distributed sensors, however, Brillouin distributed sensors may also be utilized to detect the strain (e.g., tensile strain) in the optical fiber sensor. That is, a change in the strain within the optical fiber sensor will also cause a wavelength shift in the Brillouin backscattered light components due to a change in the optical density of the optical fiber sensor. As a result, the strain that is experienced by the optical fiber sensor at any point along its length can be determined, and hence the strain experienced by the fiber-reinforced composite strength member can also be determined.

Brillouin distributed sensors may be configured to implement a spontaneous Brillouin-based technique, i.e., Brillouin optical time domain reflectometry (BOTDR), or a stimulated Brillouin based technique, i.e., Brillouin optical time domain analysis (BOTDA). One advantage of a BOTDR configuration is that a single coherent pump light source can be utilized, i.e., at one end of the optical fiber sensor. In certain systems, BOTDR also offers the capability of simultaneously measuring the temperature and strain in a single optical fiber sensor. However, the detected backscattered light signal is typically very weak, requiring signal processing and a long integration time.

In another configuration, the Brillouin distributed interrogation device implements a BOTDA technique. In BOTDA, a counter-propagating input light signal (sometimes referred to as a “probe” signal or a “counter wave” signal) having a wavelength difference that is equal to the Brillouin shift is used. This probe signal reinforces the phonon population in the optical fiber sensor, resulting in a higher signal-to-noise ratio. When the primary (pump) light signal is a short pulse, and its reflected intensity is analyzed in terms of flight time and wavelength shift, it is possible to obtain a profile of the Brillouin shift along the length of the optical fiber sensor. BOTDA techniques generally require the two counter propagating light signal wavelengths to be very stable (e.g., synchronized laser sources). Advantageously, a temperature resolution of less than 1.0° C. or even less than 0.5° C. may be achieved. Further, very small strain shifts experienced by the optical fiber sensor may be detected.

Thus, an interrogation device implementing Brillouin distributed sensing is useful for temperature monitoring and is uniquely suited for the measurement of strain. In this regard, it is typically necessary to know the wavelength shift in the optical fiber at a reference temperature in order to calculate the absolute temperature at any point along the optical fiber. It is also typically necessary to know the wavelength shift of the unstrained fiber in order to enable an absolute strain measurement. In any event, the determination of strain in the overhead electrical cable, e.g., in a strength member, over its length may be used to determine the tension in the electrical cable. The tension may then be used to determine, for example, the sag along the electrical cable, whether the sag results from thermal loads or from mechanical loads, e.g., from icing events. Sag of the cables can lead to contact of an electrical cable with objects underneath the electrical line. If the sag across the three cables in a single circuit is not uniform, one electrical cable may come into contact with another cable directly below, causing a flashover.

In addition to temperature and strain, optical fibers can be utilized as distributed acoustic sensors, e.g., vibration sensors, for the detection of events such as Aeolian vibration, galloping, Corona discharge, and the like. Aeolian vibration is caused by low speed cross winds impinging on the overhead cable. This results in a low amplitude, high frequency vibration in the cable that may cause fatigue damage to the cable. Galloping is a large amplitude, low frequency movement of waves through the cable, typically caused by a moderately strong, steady crosswind, e.g., acting upon an asymmetrically-iced conductor surface. Galloping can cause cable damage and can also cause flashover if the amplitude of the waves is excessive. Distributed acoustic sensing optical fibers may be operatively connected to an interrogation device, e.g., an interrogation device that is configured to detect Rayleigh backscatter components from the optical fiber.

According to the present disclosure, the properties of one or more overhead electrical cable segments may be interrogated (e.g., monitored) in real time during operation of the electrical line, e.g., during operation of the electrical grid, thereby enabling the systems and methods disclosed herein to actively monitor and operate the electrical lines in real time. As used herein, the term “real time” does not (necessarily) imply an immediate response time of seconds, but is broadly construed to mean that the properties are measured and an action may be taken within a relatively short period of time, e.g., within an hour or less, as the operator is receiving the information from the distributed sensors rapidly, e.g. with 30 minutes or less of making a query of an interrogation device. Such systems and methods may include the continuous or semi-continuous interrogation of the overhead electrical cables to detect, for example, temperature conditions, strain conditions, vibrations, mechanical load and/or elongation of the overhead electrical cables and acting in response to certain identified conditions. From a determination of these conditions, other conditions and/or states may be determined, such as the sag of a particular electrical cable segment or the electrical current carried by an electrical cable segment.

Although distributed sensing elements such as optical fiber sensors are preferred for implementing the methods of the present disclosure, the present disclosure is not limited to such devices and systems. For example, in some embodiments, non-distributed sensors may be utilized, either independently or in conjunction with distributed sensors. Non-distributed sensors are sensors that are disposed at intervals along the electrical line, e.g., along an electrical cable. Examples of non-distributed sensors that may be useful for obtaining a temperature of an electrical cable include, but are not limited to, thermocouples and infrared cameras. Further, environmental sensors such as wind stations, humidity sensors and the like may be incorporated to collect data, e.g., for further refinement of the measured values.

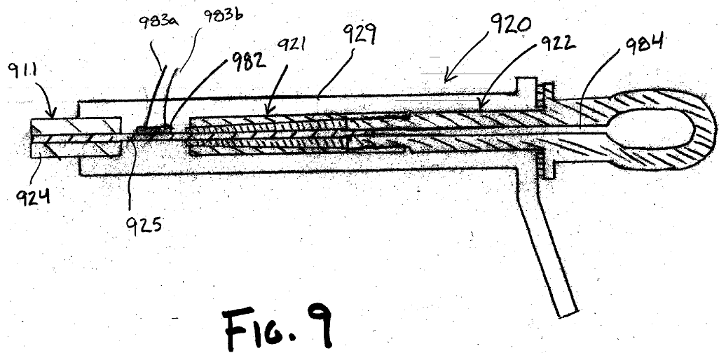

FIG. 8 illustrates a portion of an overhead electrical line that incorporates several non-distributed sensors. The electrical line 810 includes a segment of an overhead electrical cable 811 that lies between two support towers 812a and 812b. Attached directly to the electrical cable 811 is a first non-distributed sensor 882. The non-distributed sensor 882 may be characterized as a multi-functional sensor, e.g., a sensor that is capable of detecting more than one property of the electrical cable 811. One example of such a multi-functional sensor is the TLM Transmission Line Monitor available from Lindsey Manufacturing Co., Azusa, CA and the multi-functional sensor illustrated in US Patent Pub. No. 2020/0209283 by Mohr et al., which is incorporated herein by reference in its entirety. Such multi-functional sensors may be capable of detecting cable clearance above the terrain, cable sag (e.g., using an inclination sensor), electrical current and temperature. These units are self-powered, e.g., drawing power from the electrical cable, and typically include an antenna for the transmission of data, e.g., using satellite or wireless communication technology.

In some characterizations, the non-distributed sensor is not directly attached to the overhead electrical cable. For example, FIG. 8 also illustrates a camera 886 that is mounted to the support tower 821b in a manner to permit the camera to image the overhead electrical cable 811. The camera 886 may include an infrared capability to enable the camera to detect the temperature of the electrical cable 811. The camera 886 may also include visible imaging capability, e.g., such that image analysis can indicate the sag of the electrical cable 811. As with the multi-functional sensor 882, the camera 886 may include an antenna or similar device for wireless communication of data.

It will also be appreciated that non-distributed sensors may be utilized to collect data that is not directly obtained from the overhead electrical cable. For example, FIG. 8 illustrates a weather station 884 that is operatively attached to the support tower. Such a weather station 884 may be capable of detecting ambient conditions such as wind speed, wind direction, solar radiation level, humidity, and the like. As these ambient conditions may influence the conditions of the electrical cable, the knowledge of these conditions may be useful for assessing the properties of the electrical cable, e.g., using a distributed sensor.

Other non-distributed sensors may be attached to the electrical cable in a manner that protects the sensor from the external environment, and/or in a manner that enables the sensor to detect a particular condition of the electrical cable. FIG. 9 illustrates one embodiment of such a non-distributed sensor. As illustrated in FIG. 9, a dead-end apparatus 920 secures an overhead electrical cable 911, e.g., in manner similar to the dead-end apparatus illustrated in FIG. 2. A gripping assembly 921 is secured to a strength member 925, e.g., to a segment of the strength member that has been stripped of the electrical conductor 924 to expose the strength member. The sensor 982 is attached directly to that exposed portion of strength member 925, e.g., using an epoxy or other means of attachment. In one characterization, the sensor 982 is a strain sensor that is capable of measuring the strain of the strength member when it is coupled to the strength member. Because the sensor 982 is located between the gripping assembly 921 and the electrical conductor 924, the strain under the sensor will be indicative of the strain experienced by the entire electrical cable 911. It also advantageous that when the dead-end apparatus is installed, the sensor 982 will be protected from the environment, e.g., by the outer sleeve 929. In this regard, access to the sensor 982 may be provided by leads 983a/983b, e.g., that are ported through the outer sleeve 929 as illustrated, or are ported back through the gripping assembly 921 and connector 922 for access through a port 984.

The foregoing components of an interrogation system may be integrated using various communication and control protocols to enable a user, e.g., a utility operator, to effectively manage the electrical lines and hence the electrical grid comprising the electrical lines. For example, the interrogation device(s), e.g., OTDRs, along the electrical line may be operatively connected to a remote terminal unit (RTU), where the RTU is configured to communicate with, e.g., to transmit data to, a server such as a data acquisition server (DAS). The OTDR may be connected to the RTU internally, e.g., where the RTU is built into the OTDR, or may be connected to an external RTU. In any event, the RTU may communicate with a server using one or more communication protocols including wireless protocols such as cellular and/or satellite communication, or wired protocols such as by directly connecting the RTU to an optical ground wire (OPGW) that includes telecommunication fibers.

The server, e.g., a DAS, may include logical processor(s) configured (e.g., programmed) to convert the raw data, e.g. distributed temperature and/or strain data received from the RTU, into readable measurements of temperature values and strain values. For example, the DAS may calculate the temperature along the overhead cable as a function of position. These values may then be transmitted to a human machine interface (HMI) such as a computer or other device capable of displaying the information for observation and/or action to be taken. In one implementation, the HMI is configured to overlay the temperature and/or strain values onto a geographical map display representing the electrical grid or a portion of an electrical grid.

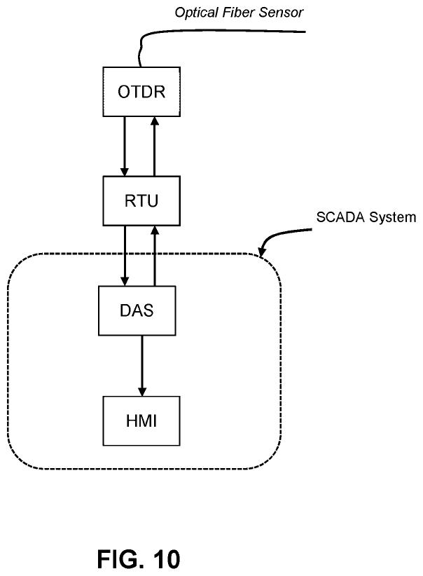

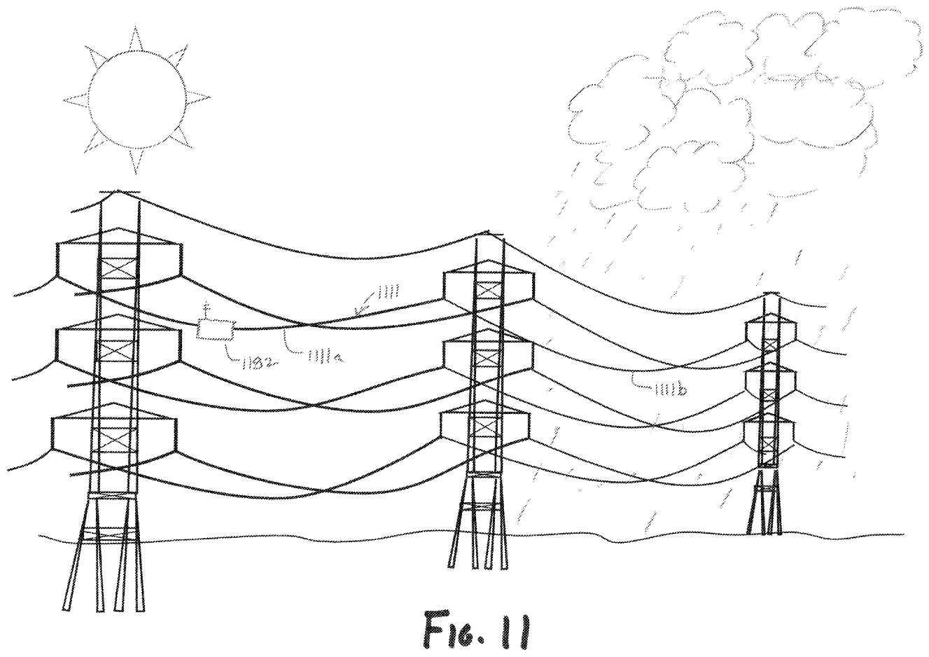

FIG. 10 illustrates a schematic of one such system. As illustrated in FIG. 10, the DAS and HMI may be a stand-alone system, or may be integrated with a user's database system, e.g., a supervisory control and data acquisition (SCADA) system. SCADA systems are widely implemented throughout the utility industry and the integration of the distributed data from the OTDR into such a SCADA system will advantageously enable an operator to refine its control over the electrical lines, and hence the electrical grid or a portion thereof, by collecting and analyzing distributed data in essentially real time, e.g., where the data includes a temperature and/or a strain profile across the electrical line. Although the systems and methods are frequently described herein as being implemented with a SCADA system, it will be appreciated that the communication of data, e.g., from an interrogation device, may be made to any type of database system for data storage and/or to inform an action such as a control operation.

In one particular embodiment, a method for operating an overhead electrical line is disclosed. The overhead electrical line may be a component of a transmission line or a distribution line. Broadly characterized, the method may include collecting distributed condition data from an optical fiber sensor extending along a length of an overhead electrical cable while the overhead electrical line is energized. The collected data may include distributed cable temperature data and/or distributed cable strain data. Thereafter, and based upon the collected distributed condition data, the current (e.g., the amperage) in the overhead electrical cable is adjusted from a first current to a second current, e.g., where the adjusting of the current reduces the absolute difference, e.g., |x−y)|, between the first current and an allowable current. The use of a distributed sensor to collect the distributed condition data in near real-time advantageously enables an operator to know the actual temperature of the electrical cable and take immediate action based upon the data. For example, if the ambient temperature surrounding the overhead electrical line is very low, and/or a strong cross-wind is traversing the electrical line, the operator may be able to increase the amperage in the electrical line without exceeding the absolute maximum operating temperature of the electrical line. Conversely, if the ambient temperature is very high and/or the solar radiation is very high, the operator may use the near real-time temperature data to decrease the amperage to a safer level such that the line temperature decreases.

For example, the method may include the step of determining the allowable current for the overhead electrical cable at the first time from the distributed condition data, e.g., determining the allowable current from the near real-time temperature of the overhead electrical cable. When the allowable current is greater than the first current, e.g., where the electrical line is operating below the temperature rating of the electrical cable (e.g., below its rated capacity), the step of adjusting current in the overhead electrical cable may include increasing the current in the overhead electrical cable, e.g., such that the temperature of the electrical cable increases to a value that is closer to the temperature rating of the electrical cable. When the allowable current is less than the first current, e.g., when the electrical line is operating near or above its temperature rating, the step of adjusting current in the overhead electrical cable may comprise decreasing the current in the overhead electrical cable. In certain characterizations, the step of adjusting current in the overhead electrical cable includes stopping the electrical current, e.g., by shunting electrical power from the overhead electrical line to a second overhead electrical line, or to electrical ground.

In one implementation, the method may include collecting non-distributed condition data associated with the overhead electrical cable. For example, the step of determining the allowable current for the overhead electrical cable may comprise supplementing the distributed condition data with the non-distributed condition data, e.g., to calculate the allowable current. The non-distributed condition data may include, for example, at least one of an ambient temperature, a wind speed, a solar radiation value and a precipitation value such as a rainfall quantity and/or a snowfall quantity.

As noted above, the distributed condition data may include distributed cable temperature data. Because the data is distributed in nature, the cable temperature data may include a localized temperature value in the overhead electrical cable, e.g., the temperature of the cable at a specific location along the cable, which may be different that an average temperature of the cable due to a defect in the cable or due to a localized weather event.

As also noted above, the distributed condition data may include distributed cable strain data. As with the cable temperature data, the cable strain data may include a localized strain value in the overhead electrical cable, e.g., the strain experienced by the cable at a specific location along the cable, which may be different that an average strain of the cable due to a defect in the cable or due to a localized event such as a high wind event or icing of the cable creating a load on the cable.

The features discussed above with respect to the configuration of the cable and the interrogation system may be implemented with this method. For example, the optical fiber sensor may embedded within the fiber-reinforced composite strength member. In another example, the step of collecting distributed condition data comprises receiving distributed condition data from an OTDR that is operatively attached to the optical fiber sensor. The OTDR may be a BOTDR. Further, certain steps of the method may be carried out using a system including a DAS and HMI, e.g., as schematically illustrated in FIG. 10.

In another embodiment, a system for determining an electrical line power rating is disclosed. The system may include an optical fiber sensor extending along a length of an overhead electrical cable in an electrical line, the overhead electrical cable comprising a fiber-reinforced composite strength member and an electrical conductor surrounding the strength member, the optical fiber sensor being configured to provide distributed condition data along the length of the overhead electrical cable. An interrogation device is operatively connected to the optical fiber sensor and is configured to interrogate the optical fiber sensor and collect the distributed condition data from the optical fiber sensor, wherein the distributed condition data includes at least distributed temperature data. A data acquisition server (DAS) is configured to receive and analyze the distributed condition data from the interrogation device. Such a system may advantageously be configured to implement the foregoing method for operating an overhead electrical line.

The DAS may be configured to receive and analyze the distributed condition data by calculating an allowable current for the overhead electrical cable based on the distributed condition data and outputting the allowable current to a control device. In one implementation, the DAS is configured to receive and analyze the distributed condition data by calculating a real time current carrying capacity of the overhead electrical cable, e.g., based on the near real-time cable temperature, and calculating a rate of change of temperature of the overhead electrical cable as a function of a change in current flowing through the overhead electrical cable.

The DAS may also be configured to receive and analyze second distributed condition data from the interrogation device, wherein the second distributed condition data is collected by the interrogation device at a time that is later than the collection of the first distributed condition data. This process may be repeated to continually collect temperature data over time, e.g., to correlate cable temperature to the current (amperage) in the electrical line.

The control device may be a human machine interface (HMI) device. In another characterization, the control device may be an automated controller that is programmed to adjust the current in the overhead electrical cable based upon the calculated allowable current. For example, the programming instructions to adjust the current may be stored in a non-transitory medium such as a memory storage device, e.g., a solid-state or magnetic memory storage device. The DAS may also be operatively integrated with a supervisory control and data analysis (SCADA) system.

The interrogation device may also be configured to collect distributed condition data, wherein the distributed condition data distributed strain data. Strain data may be useful for the identification of cable sag, e.g., thermal sag or ice loading sag, so that the operator may take action to mitigate the detrimental effects of the sag. The actions may be similar to those described above with respect to adjusting or eliminating the current in the electrical cable using the control device, e.g., either manually or through a programmed automated controller.

As is described above, the optical fiber sensor may be embedded within the fiber-reinforced composite strength member. The interrogation device may be an optical time domain reflectometer (OTDR), such as a Brillouin optical time domain reflectometer (BOTDR). The DAS may receive the distributed condition data from the interrogation device through a remote terminal unit (RTU), for example.

In another embodiment, the systems and methods disclosed herein may be implemented to collect and supply data to a virtual model (e.g., a “digital twin”) of an electrical power grid. A virtual model is a virtual (e.g., digital) representation of a physical system that serves as the digital counterpart of the physical system for purposes such as operation, simulation, testing, monitoring, and maintenance. Broadly characterized, virtual models may be utilized to predict future events under a given set of conditions, and take or suggest pre-emptive actions when needed. However, the effectiveness of a virtual model is limited by the quality, e.g., the granularity of the data being supplied to the virtual model.

For application to an electrical power grid, the physical assets such as power generation stations, substations including transformers and the electrical power lines may be reproduced, or “twinned,” as virtual assets in the virtual model. The virtual model may also include a virtual representation of the environment in which the assets are placed, such as the terrain, waterways, streets, bridges, etc. Data such as cable temperature data may be obtained from non-distributed sensor(s) and input to the virtual model, enabling the output of a graphic display of the physical assets, e.g., to an HMI, to illustrate the real-time temperature of the electrical line to an operator, or to simply indicate that the electrical line is operating outside of a pre-selected temperature range, e.g., by signaling an alarm. The operator may have the ability to alter system parameters, such as by decreasing voltage or current across an electrical line in response, and/or the virtual model may be configured to facilitate an automatic adjustment to the electrical line.

A virtual model of an electrical power grid may be updated, e.g., continually or intermittently updated with new data. For example, the virtual model may collect and store data over time, referred to as historical data. This historical data may be analyzed and correlated to enable the virtual model to perform simulations of the physical system. Stated another way, the historical data can be used to predict future behavior based upon correlations from past data.

In current practice, data is collected from an electrical line and input to a virtual model using a non-distributed cable sensor, e.g., as illustrated and described with respect to FIG. 8 above. For example, as illustrated in FIG. 11, a non-distributed cable temperature sensor 1182 may be affixed to an overhead electrical cable 1111 to determine the temperature of the electrical cable at that location. However, that temperature may not be indicative of the temperature of the entire electrical cable, even at relatively short distances from the non-distributed sensor 1182. As illustrated in FIG. 11, for example, a segment 1111a of the electrical cable 1111 may be significantly warmer than a nearby segment 1111b due to a localized rain shower or other precipitation event over the segment 1111b. However, non-distributed sensors will not provide this information unless many sensors are placed along the electrical cable. Further, other non-distributed environmental sensors such as ambient temperature sensors or wind sensors may not be sufficiently co-located with the non-distributed cable sensor to provide useful data with a high level of granularity.

According the present disclosure, distributed data supplied to the virtual model such as distributed cable temperature data, cable strain data, and/or cable vibration data. Advantageously, the distributed data supplied to the virtual model may also include location data associated with the temperature data. That is, the virtual model may be supplied with sufficient location data to enable the virtual model to indicate the temperature across a length of the electrical line. A detected anomaly in the strain value of the electrical line may similarly be located and action taken by an operator if necessary.

In one embodiment, the overhead electrical line includes an overhead electrical cable having a fiber-reinforced composite strength member and an electrical conductor surrounding the fiber-reinforced composite strength member, as discussed above. The method includes determining at least a first environmental condition state from a geographical region, e.g., where at least a portion of the overhead electrical line is disposed within the geographical region. Distributed condition data is collected from one or more distributed sensor(s) associated with the overhead electrical cable while the overhead electrical line is energized. The collected distributed condition data may include at least one of cable temperature data, cable strain data and cable vibration data.

Thereafter, the environmental condition state and the distributed condition data is provided to, e.g., is communicated to, a virtual model of the electrical power grid.

The environmental condition state is a qualitative or quantitative value that relates an environmental condition, e.g., an ambient condition, within which the electrical line is placed. By way of example, the environmental condition state may be qualitative, e.g., a determination that it is raining, or may be a quantitative value such as a temperature value, e.g., an ambient temperature value, a wind speed value, a wind direction value, a solar radiation value, or a precipitation value such as a precipitation amount over a time period or a precipitation rate. In one implementation, the environmental condition state is determined, e.g., quantitatively, from a non-distributed sensor, such as a temperature sensor, a wind sensor, a solar radiation sensor and a precipitation sensor. In another implementation, the environmental condition state is determined from a weather report, e.g., qualitatively or quantitively from weather radar data or the like which may indicate the presence of precipitation, wind speed, ambient temperature, etc.

In one implementation, the virtual model updates, e.g., adds to, historical model data within the virtual model based on the environmental condition state and the distributed condition data input to the virtual model. Updating of the historical model data may also include correlating the environmental condition state to the distributed condition data, e.g., so that the historical data may be used to run simulations in the virtual model. In addition, the a voltage or current may be determined in at least the portion of the overhead electrical line that is within the geographical region. This voltage or current value may then also be correlated with the distributed condition data and/or the environmental condition state. In a further implementation, the virtual model may receive a future weather forecast for the geographical region and virtually model a future electrical line condition based upon the future weather forecast. This modeling may include the application of the correlated environmental condition state to the distributed condition data. Further, the modeling may output a predicted voltage or current value for the portion of the overhead electrical line in the geographical region, wherein the predicted voltage or current value is a value such that a pre-selected temperature of the overhead electrical line, e.g., a maximum allowable temperature, is not exceeded.

In the foregoing embodiments wherein a virtual model is generated and/or updated, the results may be output to a graphical user interface (GUI) for observation and/or interaction by an operator. Such a GUI may include the illustration of underlying terrestrial elements such as streets, highways, bodies of water, bridges, buildings, topographical information such as elevation and the like. Electrical grid infrastructure may be laid over these elements, such as power generation facilities, transmission lines, substations, distribution lines, support towers, etc. In this manner, the state of the transmission lines and/or distribution lines can be graphically illustrated to the operator, e.g., in a manner that the operator can readily ascertain the temperatures and/or strain of a particular electrical line.

It is well known that increasing the current applied to an electrical cable will increase the temperature of the electrical cable due to Joule heating. Electrical cables have an absolute maximum operating temperature, referred to as a “temperature rating.” The “ampacity” of a given electrical cable is the maximum current, in amperes, that an electrical cable can continuously carry without exceeding its temperature rating, e.g., without damaging the electrical cable due to the elevated heat.

The ampacity of an electrical cable therefore limits the amount of current that an operator can continuously apply to an electrical line that includes the electrical cable. While electrical current can be stepped-up almost instantaneously across an electrical line, the resultant temperature increase of the electrical cable will lag and the final steady-state temperature of the electrical cable at the increased current will not be reached until some period of time has passed. The rate of change of the electrical cable temperature (ΔT_{c}) associated with a step-up in current is approximately exponential and the can be quantified using a thermal time constant (τ), which is typically on the order of 5 minutes to 20 minutes for most electrical transmission lines. Thus, an operator may be able to take advantage of this non-steady state (e.g., transient) condition to apply a current that exceeds the maximum current that is allowable under steady-state conditions.

However, known techniques for determining the amperage that can be safely applied for a selected time period are based on the assumption that other factors that can affect the cable temperature, such as ambient temperature, wind speed, wind direction, solar radiation, etc., are constant. In fact, these factors can vary significantly over time and over the length of the electrical line. This requires that the operator have concurrent data about these factors to make an accurate assessment of the maximum allowable applied current. Such concurrent data is typically collected using non-distributed sensors.

In one embodiment, a method for the operation of an electrical line includes enabling the safe operation of the electrical line in a non-steady state condition for a desired period of time (t) in a manner that ensures that a steady-state constraint will not be exceeded. As applied to the scenario above, the method enables a line operator to temporarily increase the amperage of the applied current on the electrical line to a value that would yield a cable temperature in excess of a desired maximum temperature if the system were allowed to come to a steady state condition. In this way, an operator may temporarily apply a higher current to the electrical line than would otherwise be allowable, without subjecting the line to operating temperatures in excess of the desired maximum temperature. In one implementation, the method may be carried out using a distributed sensor associated with the electrical cable, which may reduce or eliminate the need for non-distributed sensors. The use of a distributed sensor enables accurate and near real-time temperature measurement of the electrical cable, which can be applied in a manner that does not rely upon knowledge of the ambient conditions to accurately determine the amount of elevated current that can be applied, since the ambient conditions are accounted for in the distributed sensor measurement.

As used herein, the “maximum desired temperature” (T_{c}) is any temperature value that is selected by the operator as an upper temperature limit for the line. While the maximum desired temperature may be the temperature at which the electrical line is susceptible to permanent damage, e.g., the temperature rating of the electrical cable discussed above, the operator may select another maximum desired upper temperature limit. Thus, although the remainder of this description refers to the temperature rating of the electrical cable as the maximum desired temperature, other temperatures may be selected by an operator for the maximum desired temperature.

In one embodiment, a method for temporarily operating an overhead electrical line in a non-steady state condition is disclosed, which enables the non-steady state condition to be utilized without exceeding an upper steady state condition. In this embodiment, an applied current amperage (I_{f}) is determined, where the applied current would exceed the temperature rating (T_{c}) of the electrical line if the current were applied for a sufficient amount of time to reach a steady-state condition. That is, the electrical line may be operated at a current that would yield a steady-state temperature above the temperature rating of the electrical cable, but for a brief period of time that will not enable the electrical line to arrive at the steady-state temperature. Stated another way, the value of I_{f} is determined where I_{f} will cause the electrical cable to reach its temperature rating within the allotted time.

The method may include the step of determining a steady state thermal time constant (τ) for the overhead electrical cable for at least a first cable temperature (T₁) and a second cable temperature (T₂).

In one implementation, the steady state thermal time constants are determined from previously collected data for the electrical line. In this implementation, the collected data points includes the temperature of the electrical cable correlated to the amperage in the electrical cable. This collection of data eliminates the need for knowledge of ambient conditions. As a result, the thermal time constant can be determined from two previously collected data points, e.g., a temperature T₁ correlated to an amperage of I₁ and a temperature T₂ correlated to an amperage of I₂.

If the correlating data is unavailable, e.g., during the early stages of operation of the electrical line, the thermal time constant τ may be determined by applying two different amperages to the electrical line Iᵢ and I_{f}, allowing the electrical line to come to a steady-state, and measuring the corresponding temperatures Tᵢ and T_{f}.

The thermal time constant can be determined using the equation:

$$τ = \frac{( {T}_{f} - {T}_{i} ) \cdot ( {mC}_{p} )}{R ( {T}_{c} ) \cdot ( {I}_{f}^{2} - {I}_{i}^{2} )}$$

where:
   τ=thermal time constant of the electrical cable;
   Tᵢ=initial cable temperature;
   T_{f}=final cable temperature;
   m=mass;
   Cₚ=heat capacity;
   R(T_{c})=AC resistance of the conductor at conductor temperature T_{c};
   I_{f}=final current; and
   Iᵢ=initial current.

With the known thermal time constant, an initial cable temperature (Tᵢ) is measured using a distributed sensor associated with the electrical cable, and an initial line current (li) is determined that is associated with the initial line temperature. Advantageously, the current in the electrical cable can also be determined using the distributed sensor, e.g., by using a BOTDR and analyzing the Brillouin frequency shift to correlate the frequency shift to an amperage.

A time period (t) for operating at the elevated current is selected, e.g., by the line operator. Then, the steady-state final temperature (T_{f}) is determined using τ, t, Tᵢ and T_{c}. For example:

$${T}_{f} = ( \frac{( {T}_{c} - {T}_{i} )}{l - {e}^{- t / τ}} ) - {T}_{i}$$

Once the value of T_{f} is determined, the final current (I_{f}) can be determined as follows:

$${I}_{f} = \sqrt{( \frac{( {T}_{f} - {T}_{i} ) \cdot {MC}_{p}}{R ( {T}_{c} )} ) + {I}_{i}^{2}}$$

The operator may then apply an elevated current I_{f} for a time t without exceeding the thermal rating T_{c} of the electrical cable.

While various embodiments of a method and system for operating an electrical line have been described in detail, it is apparent that modifications and adaptations of those embodiments will occur to those skilled in the art. However, is to be expressly understood that such modifications and adaptations are within the spirit and scope of the present disclosure.

What is claimed is:

1. A method for operating an overhead electrical line, comprising the steps of:
collecting distributed condition data at a first time from an optical fiber sensor extending along a length of an overhead electrical cable while the overhead electrical line is energized at a first current, the overhead electrical cable comprising a fiber-reinforced composite strength member and an electrical conductor surrounding the fiber-reinforced composite strength member, wherein the distributed condition data comprises at least one of distributed cable temperature data and distributed cable strain data; and
adjusting first current in the overhead electrical cable from the first current to a second current, wherein the adjusting reduces the absolute difference between the first current and an allowable current.

2. The method recited in claim 1, further comprising the step of determining the allowable current for the overhead electrical cable from the distributed condition data.

3. The method recited in any one of claim 1 or 2, wherein:
the allowable current is greater than the first current; and
the step of adjusting current in the overhead electrical cable comprises increasing the current in the overhead electrical cable.

4. The method recited in any one of claim 2, wherein:
the allowable current is less than the first current; and
the step of adjusting current in the overhead electrical cable comprises decreasing the current in the overhead electrical cable.

5. The method recited in claim 4, wherein the step of adjusting current in the overhead electrical cable comprises shunting electrical power from the overhead electrical line to a second overhead electrical line or to ground.

6. The method recited in any one of claims 1 to 5, further comprising:
collecting non-distributed condition data associated with the overhead electrical cable, wherein the step of determining the allowable current for the overhead electrical cable comprises supplementing the distributed condition data with the non-distributed condition data.

7. The method recited in claim 6, wherein the non-distributed condition data comprises at least one of an ambient temperature, a wind speed, a solar radiation value and a precipitation value.

8. The method recited in any one of claims 1 to 7, wherein the distributed condition data comprises at least distributed cable temperature data.

9. The method recited in claim 8, wherein the cable temperature data comprises a localized temperature value in the overhead electrical cable.

10. The method recited in any one of claims 1 to 9, wherein the distributed condition data comprises at least distributed cable strain data.

11. The method recited in claim 10, wherein the distributed cable strain data comprises a localized strain value in the overhead electrical cable.

12. The method recited in any one of claims 1 to 11, wherein the optical fiber sensor is embedded within the fiber-reinforced composite strength member.

13. The method recited in any one of claims 1 to 12, wherein the step of collecting distributed condition data comprises receiving distributed condition data from an OTDR (optical time domain reflectometer) that is operatively attached to the optical fiber sensor.

14. The method recited in claim 13, wherein the OTDR is a BOTDR (Brillouin optical time domain reflectometer).

15. The method recited in any one of claim 13 or 14, wherein the OTDR is operatively connected to a remote terminal unit (RTU), and wherein the RTU transmits the distributed condition data to a data acquisition server (DAS).

16. The method recited in claim 15, wherein the DAS transmits data to a supervisory control and data acquisition (SCADA) system.

17. A system for determining an electrical line power rating, the system comprising:
an optical fiber sensor extending along a length of an overhead electrical cable in an electrical line, the overhead electrical cable comprising a fiber-reinforced composite strength member and an electrical conductor surrounding the strength member, the optical fiber sensor being configured to provide distributed condition data along the length of the overhead electrical cable; and
an interrogation device operatively connected to the optical fiber sensor and being configured to interrogate the optical fiber sensor and collect the distributed condition data from the optical fiber sensor, wherein the distributed condition data includes at least distributed temperature data;
a data acquisition server (DAS) configured to receive and analyze the distributed condition data from the interrogation device.

18. The system recited in claim 17, wherein the DAS is configured to receive and analyze the distributed condition data by calculating an allowable current for the overhead electrical cable based on the distributed condition data and outputting the allowable current to a control device.

19. The system recited in claim 18, wherein the DAS is configured to receive and analyze the distributed condition data by calculating a real time current carrying capacity of the overhead electrical cable and calculating a rate of change of temperature of the overhead electrical cable as a function of a change in current flowing through the overhead electrical cable.

20. The system recited in any one of claims 17 to 19, wherein the DAS is configured to receive and analyze second distributed condition data from the interrogation device, wherein the second distributed condition data is collected by the interrogation device at a time that is later than the collection of the first distributed condition data.

21. The system recited in any one of claims 17 to 20, wherein the control device is a human machine interface (HMI) device.

22. The system recited in any one of claims 18 to 21, wherein the control device is an automated controller that is programmed to adjust the current in the overhead electrical cable based upon the calculated allowable current.

23. The system recited in any one of claims 17 to 22, wherein the DAS is operatively integrated with a supervisory control and data analysis (SCADA) system.

24. The system recited in any one of claims 17 to 23, wherein the interrogation device is further configured to collect distributed condition data, wherein the distributed condition data further includes distributed strain data.

25. The system recited in any one of claims 17 to 24, wherein the optical fiber sensor is embedded within the fiber-reinforced composite strength member.

26. The system recited in any one of claims 17 to 25, wherein the interrogation device is an optical time domain reflectometer (OTDR).

27. The system recited in claim 26, wherein the interrogation device is a Brillouin optical time domain reflectometer (BOTDR).

28. The system recited in any one of claims 17 to 27, wherein the DAS receives the distributed condition data from the interrogation device through a remote terminal unit (RTU).

29. A method for operating an electrical power grid comprising an overhead electrical line, the overhead electrical line comprising an overhead electrical cable having a fiber-reinforced composite strength member and an electrical conductor surrounding the fiber-reinforced composite strength member, the method comprising the steps of:
determining at least a first environmental condition state from a geographical region, wherein at least a portion of the overhead electrical line is disposed within the geographical region;
collecting distributed condition data from a distributed sensor associated with the overhead electrical cable while the overhead electrical line is energized, where the distributed condition data comprises at least one of cable temperature data, cable strain data and cable vibration data from at least the portion of the overhead electrical line that is disposed within the geographical region; and
providing the environmental condition state and the distributed condition data to a virtual model of the electrical power grid.

30. The method recited in claim 29, wherein the environmental condition state comprises at least one of an ambient temperature value, a wind speed value, a solar radiation value and a precipitation value.

31. The method recited in any one of claim 29 or 30, wherein the environmental condition state is determined from a non-distributed sensor.

32. The method recited in claim 31, wherein the non-distributed sensor is selected from a temperature sensor, a wind sensor, a solar radiation sensor and a precipitation sensor.

33. The method recited in any one of claim 29 or 30, wherein the environmental condition state is determined from a weather report.

34. The method recited in any one of claims 29 to 33, wherein the step of collecting distributed condition data comprises collecting distributed cable temperature data.

35. The method recited in any one of claims 29 to 34, wherein the step of collecting distributed condition data comprises collecting distributed cable strain data.

36. The method recited in any one of claims 29 to 35, wherein the step of collecting distributed condition data comprises collecting distributed cable vibration data.

37. The method recited in any one of claims 29 to 36, wherein the virtual model updates historical model data within the virtual model based on the environmental condition state and the distributed condition data input to the virtual model.

38. The method recited in claim 37, wherein the update to the historical model data includes the step of correlating the environmental condition state to the distributed condition data.

39. The method recited in claim 38, further comprising the step of:
determining a voltage or current in at least the portion of the overhead electrical line that is within the geographical region; and
correlating the determined voltage or current in the portion of the overhead electrical line to the distributed condition data.

40. The method recited in any one of claim 38 or 39, further comprising the steps of:
receiving a future weather forecast for the geographical region;
modeling, in the virtual model of the electrical power grid, a future electrical line condition based upon the future weather forecast, the modeling comprising application of the correlated environmental condition state to the distributed condition data.

41. The method recited in claim 40, wherein the modeling determines a projected voltage or current value for the portion of the overhead electrical line in the geographical region, wherein the projected voltage or current value is determined such that a pre-selected temperature of the overhead electrical line is not exceeded.

42. A system for the measurement of temperature in real time in an overhead electrical line, comprising:
an overhead electrical cable comprising a fiber-reinforced composite strength member and an electrical conductor surrounding the composite strength member, wherein the overhead electrical cable is strung upon a plurality of support towers;
an optical fiber sensor embedded within and extending along a length of the composite strength member, the optical fiber sensor comprising a glass fiber core and a polymeric coating having a thickness of at least about 250 μm surrounding the glass fiber core, the optical fiber sensor having an outer diameter of at least about 600 μm; and
an optical time domain reflectometer (OTDR) operatively attached to a first end of the optical fiber sensor, wherein the OTDR is configured to measure at least temperature profile data along the length of the optical fiber sensor.

43. The system recited in claim 42, wherein the polymeric coating surrounding the glass fiber core has a thickness of at least about 300 μm.

44. The system recited in any one of claim 42 or 43, wherein the optical fiber sensor has an outer diameter of at least about 700 μm.

45. The system recited in any one of claims 42 to 44, wherein the polymeric coating surrounding the glass fiber is fabricated from a thermoplastic polymer.

46. The system recited in claim 45, wherein the thermoplastic polymer is selected from the group consisting of polyaryletherketone (PAEK), a liquid crystal polymer, a polyamide-imide and polybenzimidazole.

47. The system recited in claim 46, wherein the thermoplastic polymer is a PAEK polymer.

48. The system recited in claim 47, wherein the PAEK polymer is selected from the group consisting of polyetherketone (PEK), polyetheretherketone (PEEK), polyetherketoneketone (PEKK), polyetheretherketoneketone (PEEKK), and polyetherketoneetherketoneketone (PEKEKK).

49. The system recited in claim 48, wherein the PAEK polymer comprises PEEK.

50. The system recited in any one of claims 42 to 49, wherein an end portion of the optical fiber sensor extends beyond a first end of the composite strength member.

51. The system recited in claim 50, wherein the OTDR is operatively attached to the end portion of the optical fiber sensor.

52. The system recited in any one of claims 42 to 51, wherein the OTDR is a Brillouin optical time domain reflectometer (BOTDR).

53. The system recited in any one of claims 42 to 52, comprising a remote terminal unit (RTU) in operative communication with the OTDR.

54. The system recited in claim 53, wherein the RTU is in operative communication with a data acquisition server (DAS) to enable the RTU to transmit the temperature profile data along the length of the optical fiber sensor to the DAS.

55. The system recited in any one of claims 42 to 52, wherein the OTDR is in wireless communication with a DAS.

56. The system recited in any one of claims 42 to 52, wherein the OTDR is in communication with the DAS through an optical ground wire (OPGW).

57. The system recited in any one of claims 54 to 56, wherein the DAS is configured to convert the temperature profile data to readable temperature measurements and to transmit the readable temperature measurements to a human machine interface (HMI).

58. The system recited in claim 57, wherein the HMI includes a processor that is programmed to overlay the readable temperature measurements onto a geographical map.

59. The system recited in any one of claims 42 to 58, wherein the optical fiber sensor is a single optical fiber sensor embedded within the composite strength member.

60. The system recited in any one of claims 42 to 59, wherein the OTDR is configured to measure strain profile data along the length of the optical fiber sensor.

61. The system recited in any one of claims 42 to 60, wherein the fiber-reinforced composite strength member comprises carbon reinforcing fibers in a polymer matrix.

62. The system recited in claim 61, wherein the fiber-reinforced composite strength member comprises an insulating layer surrounding the carbon reinforcing fibers.

63. The system recited in any one of claims 42 to 62, wherein the electrical conductor comprises a plurality of aluminum strands wrapped around the composite strength member.

64. A method for increasing the current in an electrical line, comprising the steps of:
determining a steady state thermal time constant (τ) for the overhead electrical line at for at least a first temperature (T₁) and a second temperature (T₂);
measuring an initial temperature (Tᵢ) of the overhead electrical line using a distributed sensor associated with the overhead electrical cable;
measuring an initial current (Iᵢ) of the overhead electrical line associated with the initial temperature (Tᵢ);
determining a steady-state cable temperature (T_{f}) from the thermal time constant (τ), the desired application time (t), the initial line temperature (Tᵢ) and a maximum desired temperature (T_{c});
determining a final current (I_{f}) that can be applied to the overhead electrical line before exceeding the maximum desired temperature (T_{c}) of the overhead electrical line within a desired application time (t);
increasing the current in the electrical line to an amperage of I_{f} for a period of time not to exceed the desired application time (t).

65. The method recited in claim 64, wherein the step of measuring an initial current (Iᵢ) of the overhead electrical line associated with the initial temperature (Tᵢ) comprises measuring the initial current using a BOTDR.

66. The method recited in any one of claim 64 or 65, wherein the steady-state cable temperature (T_{f}) is determined from the equation:
$${T}_{f} = ( \frac{( {T}_{c} - {T}_{i} )}{l - {e}^{- t / τ}} ) - {T}_{i}$$
where:
τ=thermal time constant of the electrical cable;
t=desired application time;
Tᵢ=initial cable temperature;
T_{c}=desired maximum temperature;
T_{f}=steady-state cable temperature.

67. The method recited in any one of claims 64 to 66, wherein the applied current I_{f} is determined using the equation:
$${I}_{f} = \sqrt{( \frac{( {T}_{f} - {T}_{i} ) \cdot {MC}_{p}}{R ( {T}_{c} )} ) + {I}_{i}^{2}}$$
where:
I_{f}=final applied current in the overhead electrical cable;
Iᵢ=initial current in the overhead electrical cable;
T_{f}=final temperature of the electrical cable;
Tᵢ=initial temperature of the electrical cable;
m=mass of the electrical cable;
Cₚ=heat capacity of the electrical cable; and
R(T_{c})=AC resistance of the electrical cable at temperature T_{c}.

68. The method recited in any one of claims 64 to 67, wherein the thermal time constant τ is determined from existing data correlating known temperature values to known current values.

69. The method recited in any one of claims 64 to 68, wherein the distributed sensor comprises at least a first optical fiber.

70. The method recited in claim 69, wherein a Brillouin Optical Time Domain Reflectometer (BOTDR) is operatively connected to the at least a first optical fiber.

71. The method recited in any one of claims 64 to 70, wherein the electrical cable comprises a fiber-reinforced composite strength member.

72. The method recited in claim 71, wherein the distributed sensor is embedded within the fiber-reinforced composite strength member.
